(19) United States
(12) Patent Application Publication
(10) Pub. No.: US 2026/0107144 A1
(43) Pub. Date: Apr. 16, 2026

(54) Authentication Procedures for Edge Computing in Roaming Deployment Scenarios

(71) Applicant: Apple Inc., Cupertino, CA (US)

(72) Inventors: Shu GUO, Beijing (CN); Dawei ZHANG, Saratoga, CA (US); Haijing HU, Los Gatos, CA (US); Huarui LIANG, Beijing (CN); Mona AGNEL, Guildford (GB); Xiaoyu QIAO, Beijing (CN); Sudeep MANITHARA VAMANAN, Uttenreuth (DE); Walter FEATHERSTONE, Cirencester (GB)

(21) Appl. No.: 19/116,315

(22) PCT Filed: Sep. 29, 2022
(86) PCT No.: PCT/CN2022/122843

§ 371 Date: Mar. 27, 2025

(51) Int. Cl. H04W 12/069; H04W 36/00; H04W 84/04

(52) U.S. Cl. CPC H04W 12/069; H04W 36/0038; H04W 84/042

(57) ABSTRACT

An edge configuration server (ECS) is deployed in a home public land mobile network (HPLMN) of a user equipment (UE). The ECS receives an authentication verification message comprising at least an authorization parameter from a first network function, an identifier of a client running on the UE and an identifier corresponding to a first credential, retrieves the first credential using the identifier corresponding to the first credential, verifies the authorization parameter using the first credential and the identifier of the client running on the UE and transmits a response to the authentication verification message to the first network function.

### BACKGROUND

A user equipment (UE) may connect to an edge data network to access edge computing services. Edge computing refers to performing computing and data processing at the network where the data is generated. To establish a connection with the edge data network, the UE may have to perform an authentication procedure with an edge configuration server (ECS), It has been identified that there exists a need for authentication mechanisms for edge computing that may be used in a roaming deployment scenario.

### SUMMARY

Some exemplary embodiments are related to a method performed by an edge configuration server (ECS) deployed in a home public land mobile network (HPLMN) of a user equipment (UE). The method includes receiving an authentication verification message comprising at least an authorization parameter from a first network function, an identifier of a client running on the UE and an identifier corresponding to a first credential, retrieving the first credential using the identifier corresponding to the first credential, verifying the authorization parameter using the first credential and the identifier of the client running on the UE and transmitting a response to the authentication verification message to the first network function.

Other exemplary embodiments are related to a method performed by a first network function deployed in a home public deployed in a home public land mobile network (HPLMN) of a user equipment (UE). The method includes receiving an authentication verification message comprising at least an authorization parameter from a second network function, an identifier of a client running on the UE and an identifier corresponding to a first credential, retrieving the first credential using the identifier corresponding to the first credential, verifying the authorization parameter using the first credential and the identifier of the client running on the UE and transmitting a response to the authentication verification message to the second network function.

Still further exemplary embodiments are related to a method performed by a user equipment (UE). The method includes transmitting an application registration request to an edge configuration server (ECS) of a visited public land mobile network (VPLMN) comprising at least an edge enabler client ID, an authorization parameter and an identifier for a first credential and establishing a transport layer security (TLS) security tunnel based on the first credential.

Additional exemplary embodiments are related to a method performed by an edge configuration server (ECS) deployed in a visited public land mobile network (VPLMN) of a user equipment (UE). The method includes receiving an application registration request from the UE comprising at least an authorization parameter, an identifier of a client running on the UE and an identifier corresponding to a first credential, receiving an authentication verification response from a network function deployed in the VPLMN, the verification response comprising at least the first credential and establishing a transport layer security (TLS) security tunnel with the UE based on the first credential.

### BRIEF DESCRIPTION OF THE DRAWINGS

FIG. 1 shows an exemplary arrangement according to various exemplary embodiments.

FIG. 2 shows an exemplary user equipment (UE) according to various exemplary embodiments.

FIG. 3 shows a local breakout (LBO) roaming architecture for enabling edge applications according to various exemplary embodiments.

FIG. 4 shows a home routed (HR) roaming architecture for enabling edge applications according to various exemplary embodiments.

FIG. 5 shows a signaling diagram for authentication based on primary authentication in an LBO roaming deployment scenario according to various exemplary embodiments.

FIG. 6 shows a signaling diagram for authentication based on primary authentication in an LBO roaming deployment scenario according to various exemplary embodiments.

FIG. 7 shows a signaling diagram for authentication based on primary authentication in a HR roaming deployment scenario according to various exemplary embodiments.

FIG. 8 shows a signaling diagram 800 for authentication based on primary authentication in a HR roaming deployment scenario according to various exemplary embodiments.

### DETAILED DESCRIPTION

The exemplary embodiments may be further understood with reference to the following description and the related appended drawings, wherein like elements are provided with the same reference numerals. The exemplary embodiments relate to authentication for access to an edge data network, As will be described in more detail below, the exemplary embodiments introduce authentication mechanisms that may be used in a local breakout roaming deployment scenario or a home routed roaming deployment scenario.

The exemplary embodiments are described with regard to a user equipment (UE). However, reference to a VE is merely provided for illustrative purposes, The exemplary embodiments may be utilized with any electronic component that is configured with the hardware, software, and/or firmware to exchange information and data with the network. Therefore, the VE as described herein is used to represent any appropriate electronic component.

The exemplary embodiments are also described with regard to a fifth generation (5G) New Radio (NR) network. However, reference to a 5G NR network is merely provided for illustrative purposes. The exemplary embodiments may be utilized with any network that allows the UE to access an edge data network.

The UE may access the edge data network via the 5G NR network. The edge data network may provide the UE with access to edge computing services. Those skilled in the art will understand that edge computing refers to performing computing and data processing at the network where the data is generated. In contrast to legacy approaches that utilize a centralized architecture, edge computing is a distributed approach where data processing is localized towards the network edge, closer to the end user. This allows performance to be optimized and latency to be minimized.

The exemplary embodiments are further described with regard to an edge configuration server (ECS). The ECS may perform operations related to the authentication and authorization procedure for access to an edge data network. However, reference to an ECS is merely provided for illustrative purposes. The exemplary embodiments may be utilized with any electronic component that is configured with the hardware, software, firmware and/or cloud computing functionality to exchange information with the UE. Therefore, the ECS as described herein is used to represent any appropriate electronic component.

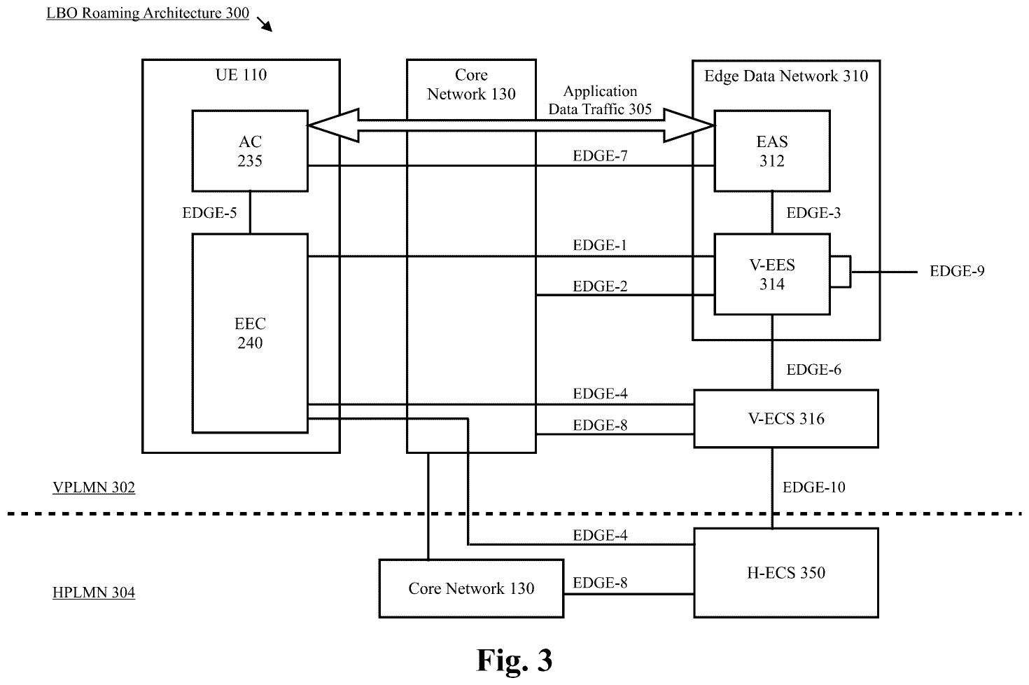

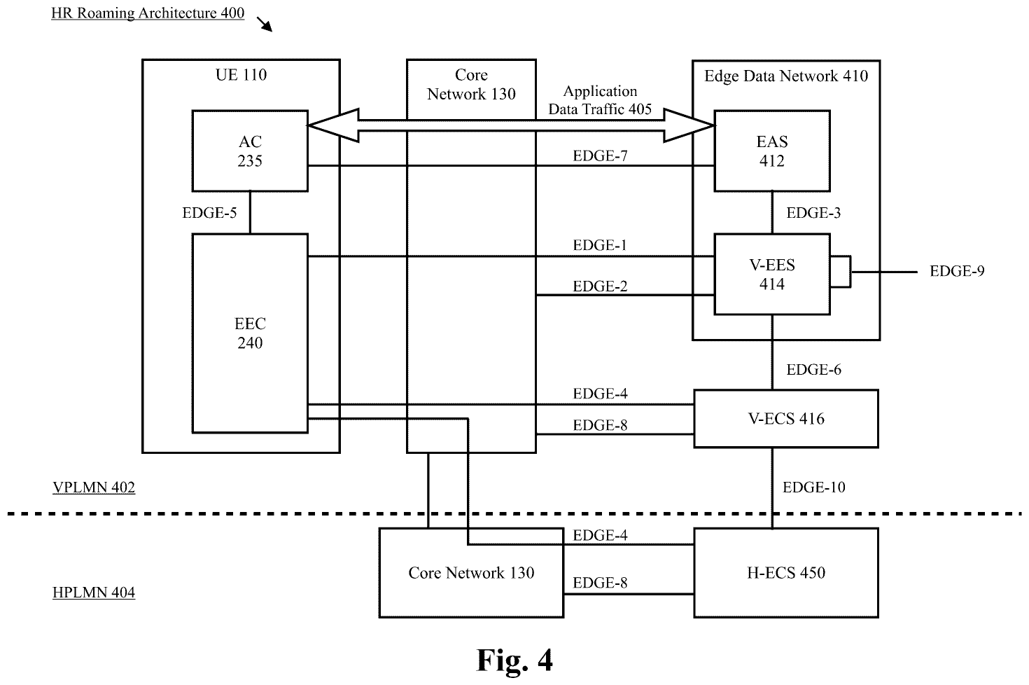

The UE and an ECS may perform an authentication and authorization procedure. According to some aspects, the exemplary embodiments introduce techniques to support the implementation of an authentication and authorization procedure in a local breakout (LBO) roaming deployment scenario. An example of an LBO roaming architecture for edge computing is provided below with regard to FIG. 3. According to other aspects, the exemplary embodiments introduce techniques to support the implementation of an authentication and authorization procedure in a home-routed (HR) roaming deployment scenario. An example of an LBO roaming architecture for edge computing is provided below with regard to FIG. 4.

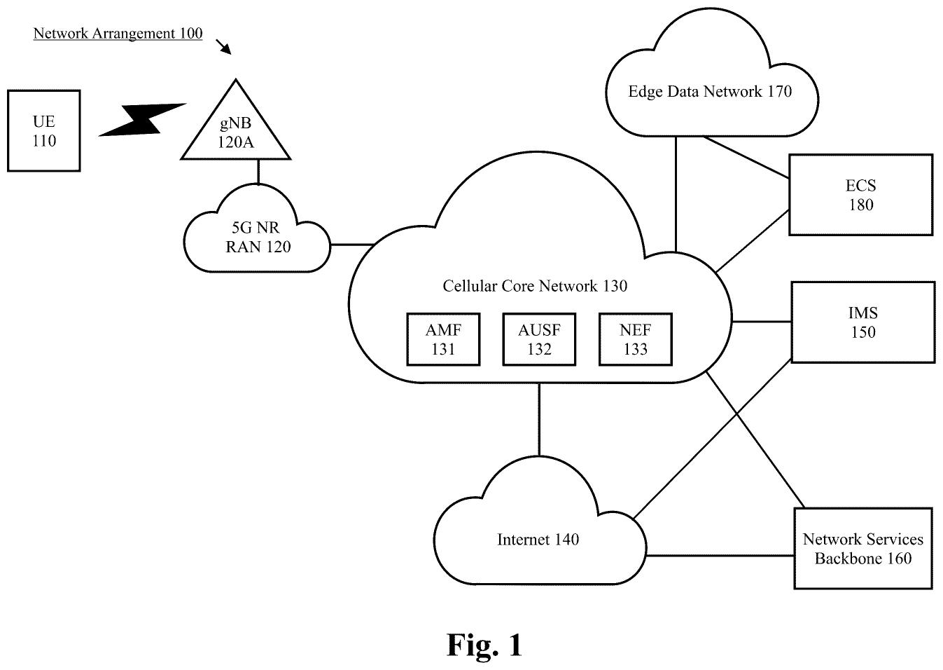

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

### The Ue 110 May Be Configured to Communicate With One

or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as indicated above, the 5G NR RAN 120 may be associated with a particular cellular provider where the UE 110 and/or the user thereof has a contract and credential information (e.g., stored on a SIM). Upon detecting the presence of the 5G NR RAN 120, the UE 110 may transmit the corresponding credential information to associate with the 5G NR RAN 120. More specifically, the UE 110 may associate with a specific base station (e.g., gNB 120A).

The network arrangement 100 also includes a cellular core network 130. The cellular core network 130 may be considered as an interconnected set of components or functions that manage the operation and traffic of the cellular network. In this example, the components include an access and mobility management function (AMF) 131, an authentication server function (AUSF) 132 and a network exposure function (NEF) 133. However, an actual network arrangement may include various other components performing any of a variety of different functions.

The AMF 131 is generally responsible for connection and mobility management in the 5G NR RAN 120. Those skilled in the art will understand that the AMF 131 is a control plane function and may perform operations related to registration management and connection management. For example, the AMF 131 may perform operations related to registration management between the UE 110 and the core network 130. The exemplary embodiments are not limited to an AMF that performs the above referenced operations. Those skilled in the art will understand the variety of different types of operations an AMF may perform. Further, reference to a single AMF 131 is merely for illustrative purposes, an actual network arrangement may include any appropriate number of AMFs.

The AUSF 132 may store data for authentication of UEs and handle authentication-related functionality. The AUSF 132 may be equipped with one or more communication interfaces to communicate with other network components (e.g., network functions, RANS, UEs, etc.), The exemplary embodiments are not limited to a AUSF that performs the above reference operations. Those skilled in the art will understand the variety of different types of operations a AUSF may perform. Further, reference to a single AUSF 131 is merely for illustrative purposes, an actual network arrangement may include any appropriate number of AUSEs.

The NEF 133 is generally responsible for securely exposing the services and capabilities provided by 5G NR-RAN 120 network functions. The NEF 133 may be equipped with one or more communication interfaces to communicate with other network components (e.g., network functions, RANs, UEs, etc.) . The exemplary embodiments are not limited to a NEF that performs the above reference operations. Those skilled in the art will understand the variety of different types of operations a NEF may perform. Further, reference to a single NEF 133 is merely for illustrative purposes, an actual network arrangement may include any appropriate number of NEFs.

The network arrangement 100 also includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the VE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

In addition, the network arrangement 100 includes an edge data network 170 and an edge configuration server (ECS) 180. Those skilled in the art will understand that an actual network arrangement may include any appropriate number of edge data networks and ECSs. Thus, the example of a single edge data network 170 and single ECS 180 is merely provided for illustrative purposes.

The exemplary embodiments are described with regard to authentication procedures for roaming deployment scenarios. An example of an LBO roaming architecture for access to an ECS of a home public land mobile network (HPLMN) (e.g., H-ECS) is provided below with regard to FIG. 3. In addition, an example of a HR roaming architecture for access to an H-ECS is. Provided below with regard to FIG. 4.

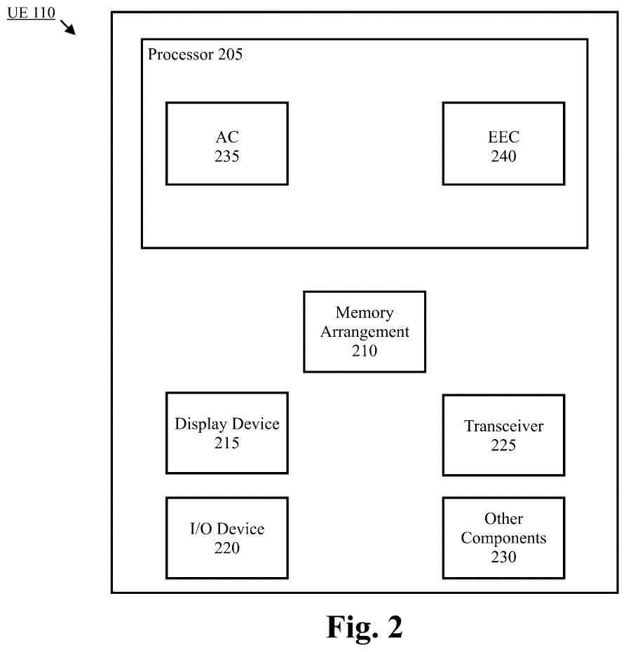

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect. the UE 110 to other electronic devices, etc.

The processor 205 may be configured to execute various types of software. For example, the processor may execute an application client (AC) 235 and an edge enabler client (EEC) 240. The AC 235 may perform operations related to exchanging application data with a server via a network. The EEC 240 may perform operations in support of the AC 235. For example, the EEC 240 may perform a negotiation procedure with an edge data network to determine which authentication procedure is to be utilized. Reference to a single AC 235 and EEC 240 is merely provided for illustrative purposes, The UE 110 may be equipped with any appropriate number of application clients supported by an appropriate number of EECs. The AC 235 and the EEC 240 are discussed in more detail below with regard to FIGS. 3-4.

The above referenced software being executed by the processor 205 is only exemplary. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

FIG. 3 shows an LBO roaming architecture 300 for enabling edge applications according to various exemplary embodiments. The architecture 300 will be described with regard to the network arrangement 100 of FIG. 1.

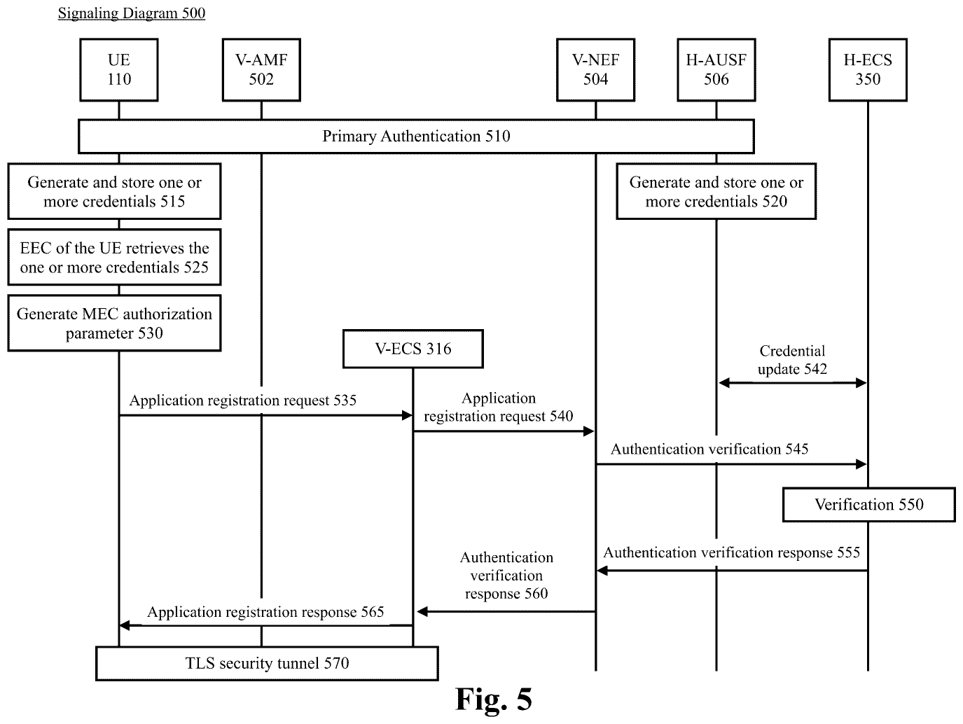

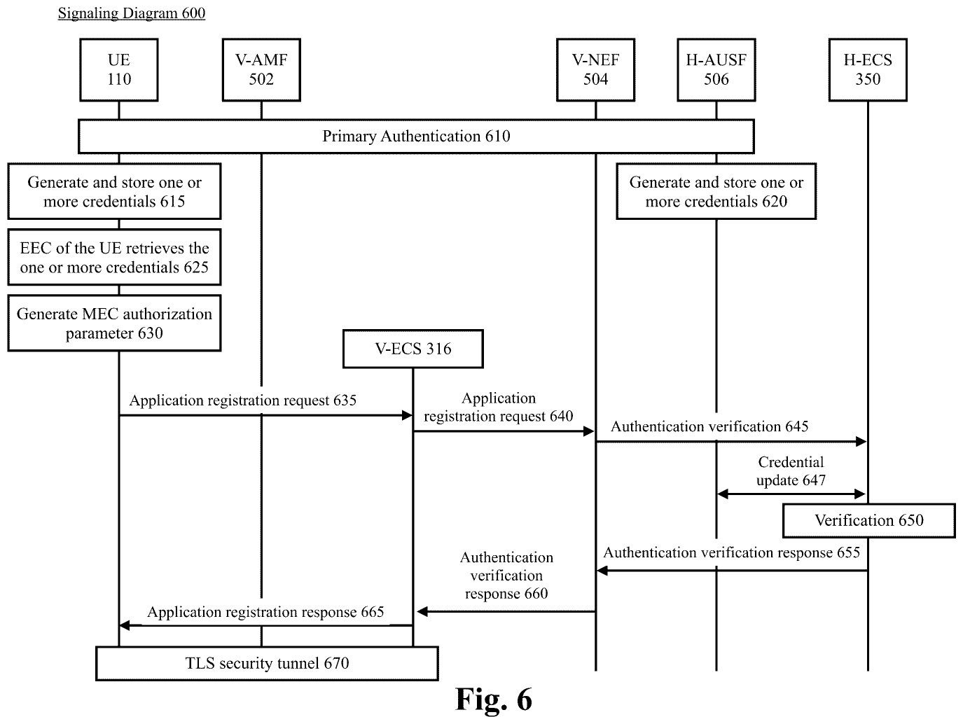

Some of the exemplary embodiments will be described with regard to an authentication procedure for access to an edge data network in an LBO roaming deployment scenario. Successful completion of the exemplary authentication procedure may precede the flow of application data traffic 305 between the edge data network 310 and the UE 110. The architecture 300 provides a general example of the type of components that may interact with one another for enabling edge applications in an LBO roaming deployment scenario. Specific examples of the exemplary authentication procedures for LBO will be provided below with regard to the signaling diagrams 500-600 of FIGS. 5-6.

The architecture 300 is described with regard to a visited public land mobile network (VPLMN) 302 and a HPLMN 304. Those skilled in the art will understand that the HPLMN 304 represents a network deployed by a mobile network operator with which the UE 110 and/or user thereof is subscribed. It should also be understood that the VPLMN 302 represents a PLMN within which the UE 110 is currently deployed and is not an HPLMN of the UE 110.

The architecture 300 shows the UE 110, the core network 130 and an edge data network 310 of the VPLMN 302. The UE 110 may establish a connection to the edge data network 310 via the core network 130 and various other components (e.g., gNB 120A, the 5G NR RAN 120, network functions, etc.) , In the architecture 300, the various components are shown as being connected via reference points labeled edge-x (e.g., edge-1, edge-2, edge-3, edge-4, edge-5, edge-6, edge-7, edge-8, edge-9, edge-10, etc.). Those skilled in the art will understand that each of these reference points (e.g., connections, interfaces, etc.) are defined in the 3GPP Specifications. In this description, these reference points may be used in the manner in which they are defined in the 3GPP Specifications and may be modified in accordance with the exemplary embodiments described here. Furthermore, while these interfaces are termed reference points throughout this description, those skilled in the art will understood that these interfaces are not required to be direct wired or wireless connections, e.g., the interfaces may communicate via intervening hardware and/or software components. To provide an example, the UE 110 may exchange signals over the air with the gNB 120A. However, in the architecture 300 the UE 110 is shown as having a direct connection to the edge application server (EAS) 312. Those skilled in the art will understand that this connection is not a direct communication link between the UE 110 and the EAS 312. Instead, this is a connection that is facilitated by intervening hardware and software components. Thus, throughout this description the terms “connection,” “reference point” and “interface” may be used interchangeably to describe the interfaces between the various components in the architectures 300-400 and the network arrangement 100.

During operation, application data traffic 305 may flow between the AC 235 running on the UE 110 and the edge application server (EAS) 312 of the edge data network 310. The EAS 312 may be accessed through the core network 130 via uplink classifiers (CL) and branching points (NP) or in any other appropriate manner. Those skilled in the art will understand the variety of different types of operations and configurations relevant to an application client and an EAS. The operations performed by these components are beyond the scope of the exemplary embodiments. Instead, these components are included in the description of the architecture 300 to demonstrate that the exemplary authentication procedure may precede the flow of application data traffic 305 between the UE 110 and the edge data network 310.

The EEC 240 may be configured to provide supporting functions for the AC 235. For example, the EEC 240 may perform operations related to concepts such as, but not limited to, the discovery of EASs that are available in an edge data network (e.g., EAS 312) and the retrieval and provisioning of configuration information that may enable the exchange of the application data traffic 305 between the AC 235 and the EAS 312. To differentiate the BEC 240 from other EECs, the EEC 240 may be associated with a globally unique value (e.g., EEC ID) that identifies the EEC 240. Further, reference to a single AC 235 and EEC 240 is merely provided for illustrative purposes, the UE 110 may be equipped with any appropriate number of application clients and EECS.

The edge data network 310 may include an edge enabler server (EES) 314. The EES 314 may be configured to provide supporting functions to the EAS 312 and the EEC 240 running on the UE 110. For example, the EES 314 may perform operations related to concepts such as, but not limited to, provisioning configuration to enable the exchange of the application data traffic 305 between the UE 110 and the EAS 312 and providing information related to the EAS 172 to the EEC 240 running on the VE 110. Those skilled in the art will understand the variety of different types of operations and configurations relevant to an BES. Further, reference to the edge data network 310 including a single EAS 312 and a single EES 314 is merely provided for illustrative purposes. In an actual deployment scenario, an edge data network may include any appropriate EASs and EESs interacting with any number of UEs.

The BCS 316 may be configured to provide supporting functions for the EEC 240 of the UE 110 to connect the EES 314. For example, the ECS 316 may perform operations related to concepts such as, but not limited to, provisioning of edge configuration information to the EEC 240. The edge configuration information may include the information for the EEC 240 to connect to the EES 314 (e.g., service area information, etc.) and the information for establishing a connection with the EES 314 (e.g., uniform resource identifier (URI). Those skilled in the art will understand the variety of different types of operations and configurations relevant to an ECS.

In the architecture 300, the ECS 316 is deployed within the VPLMN 302 (e.g., V-ECS 316) and another ECS 350 is deployed within the HPLMN 304 (e.g., H-ECS 350). In an LBO roaming deployment scenario, the EEC 240 of the UE 110 may obtain services from the V-ECS 316 and the EES 314 of the VPLMN 302 (e.g., V-EES 314). Traffic between the EEC 240 of the UE 110 may be routed to the H-ECS 240 directly from the VPLMN 302. This is shown in the example architecture 300 where EDGE-4 flows from the EEC 240 to the core network 130 on the VPLMN 302 side and then directly to the H-ECS 350 without traversing through the core network 130 on the HPLMN 404 side. Although the V-ECS 316 and the H-ECS 350 are deployed within different PLMNs, the components may be provided by a same edge computing service provider (ECSP) or a different ECSP.

In the architecture 300, the ECS 316 and ECS 350 are shown as being outside of the edge data network 310 and the core network 130. In addition, the EAS 312 and the EES 314 are shown as being inside of the edge data network 310. However, these examples are merely provided for illustrative purposes. The EAS 312, ECS 350, the EES 314 and the ECS 316 may be deployed in any appropriate virtual and/or physical location (e.g., within the appropriate mobile network operator's domain or within a third-party domain) and implemented via any appropriate combination of hardware, software and/or firmware.

FIG. 4 shows a HR roaming architecture 400 for enabling edge applications according to various exemplary embodiments. The architecture 400 will be described with regard to the network arrangement 100 of FIG. 1.

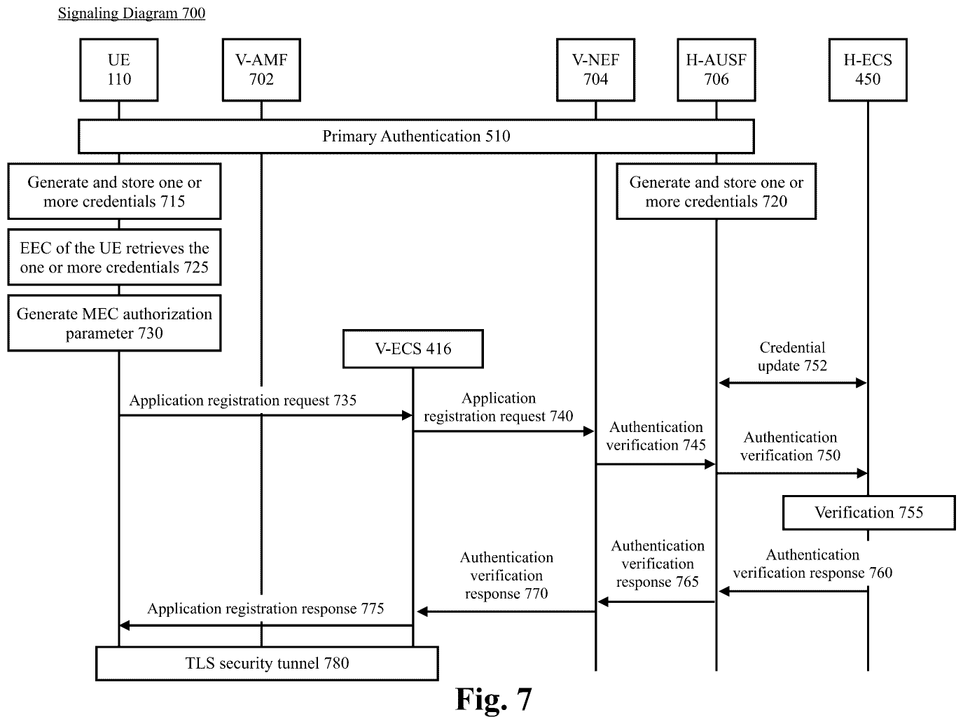

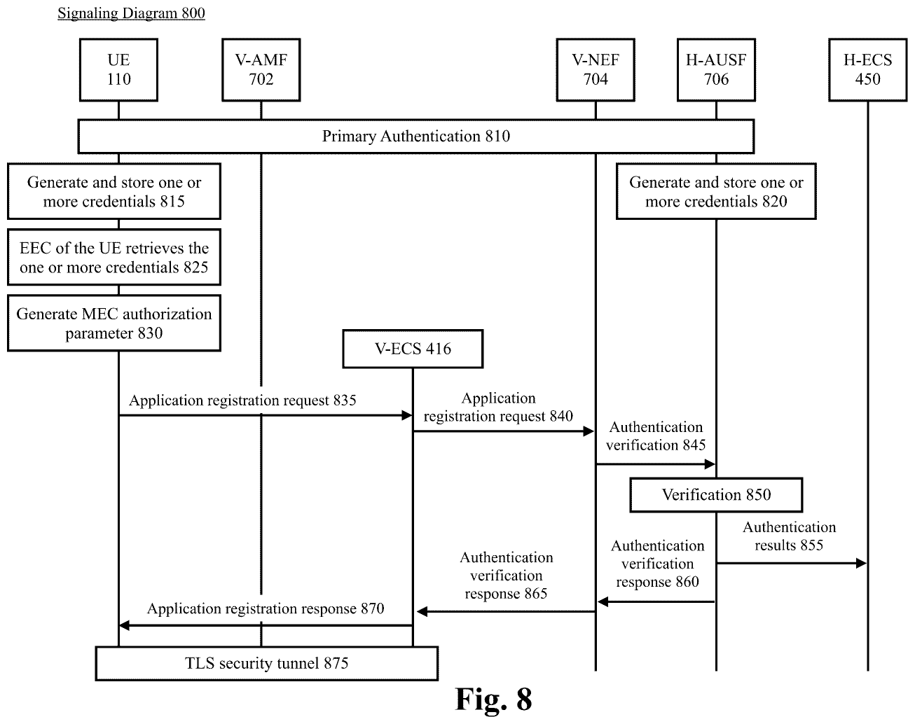

Some of the exemplary embodiments will be described with regard to an authentication procedure for access to an edge data network in an HR roaming deployment scenario. Successful completion of the exemplary authentication procedure may precede the flow of application data traffic 405 between the edge data network 410 and the UE 110. The architecture 400 provides a general example of the type of components that may interact with one another for enabling edge applications in a HR roaming deployment scenario. Specific examples of the exemplary authentication procedures for HR will be provided below with regard to the signaling diagrams 700-800 of FIGS. 7-8.

The architecture 400 is described with regard to a VPLMN 402 and a HPLMN 404. Those skilled in the art will understand that the HPLMN 304 represents a network deployed by a mobile network operator with which the UE 110 and/or user thereof is subscribed. It should also be understood that the VPLMN 302 represents a PLMN within which the UE 110 is currently deployed and is not an HPLMN of the UE 110.

The architecture 400 shows the UE 110, the core network 130 and an edge data network 410 of the VPLMN 402. The UE 110 may establish a connection to the edge data network 410 via the core network 130 and various other components (e.g., gNB 120A, the 5G NR RAN 120, network functions, etc.) .

In the architecture 300, the various components are shown as being connected via reference points labeled edge-x.

Those skilled in the art will understand that each of these reference points (e.g., connections, interfaces, etc.) are defined in the 3GPP Specifications. As mentioned above with regard to FIG. 3, in this description, these reference points may be used in the manner in which they are defined in the 3GPP Specifications and may be modified in accordance with the exemplary embodiments described here.

During operation, application data traffic 405 may flow between the AC 235 running on the UE 110 and the EAS 412 of the edge data network 410. The EAS 412, the EES 414 and the edge data network 410 are substantially similar to the EAS 312, EES 314 and the edge data network 310 described above with regard to the architecture 300 of FIG. 3.

In the architecture 400, the ECS 416 is deployed within the VPLMN 402 (e.g., V-ECS 416) and another ECS 450 is deployed within the HPLMN 404 (e.g., H-ECS 450). In a HR roaming deployment scenario, the EEC 240 of the UE 110 may obtain services from the V-ECS 416 and the EES 414 of the VPLMN 402 (e.g., V-EES 414). The traffic towards the edge data network 410 of the VPLMN 402 (e.g., EDGE-1 traffic and application data traffic 405) is not home routed to the HPLMN 404 while the traffic between the EEC 240 and H-ECS 450 is home routed via the VPLMN 402 and the HPLMN 404. This is shown in the example architecture 400 where EDGE-4 flows from the EEC 240 to the core network 130 on the VPLMN 402 side, then through the core network 130 on the HPLMN 404 side and then to the H-ECS 450. Although the V-ECS 416 and the H-ECS 450 are deployed within different PLMNs, the components may be provided by a same ECSP or a different ECSP.

In the architecture 400, the ECS 416 and ECS 450 are shown as being outside of the edge data network 410 and the core network 430. In addition, the EAS 412 and the EES 414 are shown as being inside of the edge data network 410. However, these examples are merely provided for illustrative purposes. The EAS 412, ECS 450, the EES 414 and the ECS 416 may be deployed in any appropriate virtual and/or physical location (e.g., within the appropriate mobile network operator's domain or within a third-party domain) and implemented via any appropriate combination of hardware, software and/or firmware.

As mentioned above, the exemplary embodiments introduce enhancements for negotiation of authentication procedures for edge computing. Initially, the exemplary embodiments are described with regard to LBO roaming deployment scenarios in the signaling diagrams 500-600 of FIGS. 5-6. Subsequently, the exemplary embodiments are described with regard to a HR roaming deployment scenario in signaling diagrams 700-800 of FIGS. 7-8.

FIG. 5 shows a signaling diagram 500 for authentication based on primary authentication in an LBO roaming deployment scenario according to various exemplary embodiments. The signaling diagram 500 is described with regard to the network arrangement 100 of FIG. 1, the UE 110 of FIG. 2 and the architecture 300 of FIG. 3.

The signaling diagram 500 includes the UE 110, an AMF 502 of the VPLMN 302 (e.g., V-AMF 502), an NEF 504 of the VPLMN 302 (e.g., V-NEF 504), an AUSF 506 of the HPLMN 304 (e.g., H-AUSF 506), the H-ECS 350 and the V-ECS 316.

In 510, the UE 110 performs primary authentication with the network. Those skilled in the art will understand that the primary authentication procedure (e.g., 5G authentication and key agreement (AKA), extensible authentication protocol (EAP)-AKA, etc.) generally refers to an authentication procedure between the UE 110 and the core network 130. During the procedure, the H-AUSF 506 may generate a credential K_{AUSF} via authentication vector generation. The K_{AUSF} may be shared between the UE 110 and AUSF of the HPLMN (e.g., H-AUSF 506) and the K_{AUSF} may provide the basis of the subsequent 5G key hierarchy.

In 515, the UE 110 generates and stores one or more credentials. Throughout this description, these credentials may be referred to as “K_{edge}” and “K_{edgeID}.” However, reference “K_{edge}” and “K_{edgeID}” is merely for illustrative purposes, any appropriate credential or parameter may be utilized.

In this example, the credential K_{edge} may be derived from credential K_{AUSF}. For example, the input key for a key derivation function (KDF) may be the K_{AUSF}. When deriving K_{edge}! the following parameters may also be used for the KDF: FC, P0, L0. Here, FC may represent a parameter used to distinguish between different instances of the KDF. The value for FC may be any appropriate value allocated by a 3GPP based entity. The Subscription permanent identifier (SUPI) or any other identifier associated with the UE 110 (e.g., generic public subscription identifier (GPSI), etc. ) may be used for P0. The length of the P0 parameter (e.g., SUPI, GPSI, etc.) may be used for L0. However, the above example is merely provided for illustrative purposes, the K_{edge} parameter may be derived in any other appropriate manner.

The K_{edgeID} parameter may be used to uniquely identify a K_{edge} parameter. The K_{edgeID} parameter may be generated in any appropriate manner.

In 520, the H-AUSF 506 generates and stores one or more credentials. Here, the H-AUSF 506 generates the same credentials generated by the VE 110 in 515. Thus, in this example, the H-AUSF 506 may also generate the credentials K_{edge} and K_{edgeID}. Since the credential K_{AUSF} is shared between the UE 110 and the H-AUSF 506, the UE 110 and the H-AUSF 506 may independently generate the same credentials. However, reference to K_{AUSF} is merely provided for illustrative purposes, any appropriate type of information may be used to provide the basis for the one or more credentials generated in 515 and 520.

In 525, the EEC 240 of the UE 110 retrieves the one or more credentials from local database. For example, the EEC 240 may retrieve K_{edge} and K_{edgeID} from the memory arrangement 210 of the UE 110 or these credentials may be provided to the EEC 240 by another process executed by the processor 205.

In 530, the EEC 240 of the UE 110 may generate a multi-access edge computing (MEC) message authentication code. Throughout this description, this parameter may be referred to as MAC_{EEC}. The authorization parameter may be generated using K_{edge} and the EEC ID associated with the EEC 240. For example, the MAC_{EEC} parameter may be generated using the SHA-256 hashing function. When deriving the MAC_{EEC} parameter, P0 and P1 may be used to form the input parameter S. Here, P0 represents K_{edge} and P1 represents the EEC ID. The input S shall be equal to the concatenation P0∥P1. The MAC_{EEC} parameter is identified with the N least significant bits of the output of the SHA-246 function, e.g., 32 bits, 64 bits, etc. However, the above example is merely provided for illustrative purposes, the MEC_{EEC} parameter may be derived in any other appropriate manner.

In 535, the UE 110 sends an application registration request to the V-ECS 316. The application registration request may include information such as, but not limited to, EEC ID, MAC_{EEC} and the K_{edgeID}. This message may be sent via non-access stratum (NAS), the user plane or in any other appropriate manner.

In 540, the V-ECS 316 sends an application registration request to the V-NEF 504. The application registration request may include information such as, but not limited to, EEC ID, MAC_{EEC} and the K_{edgeID}.

In 545, the V-NEF 504 sends authentication verification message to the H-ECS 350. The authentication verification message may include contents similar to the application registration requests in 535-540 (e.g., EEC ID, MEC_{EEC} and the K_{edgeID}).

Prior to receiving the authentication verification message is received in 545, in 542, the H-AUSF 506 and the H-ECS 350 perform a credential update. Here, the H-AUSF 506 and the H-ECS 350 synchronize with regard to the credentials to be used for MEC authentication (e.g., EEC ID of the EEC 240, K_{edge}, K_{edgeID}, etc.). In this example, the credential update may be triggered in response to the generation of K_{edge}, K_{edgeID} by the H-AUSF 506. In other embodiments, the credential update may be triggered by the H-ECS 350 in response to the authentication verification message. An example of this is described in more detail below with regard to the signaling diagram 600 of FIG. 6.

In 550, the H-ECS 316 verifies the credentials provided in the authentication verification message. For example, the H-ECS 350 may retrieve K_{edge} from a local or remote database using the credential K_{edgeID}. The H-ECS 350 may then verify the MAC_{EEC} using K_{edge} and the EEC ID for the EEC 240.

In 555, the H-ECS 350 sends an authentication verification response to the V-NEF 504. In this example, it is assumed that the verification was a success. Thus, the authentication verification response may indicate that the verification procedure performed by the H-ECS 350 was a success. However, if for any of a variety of different reasons, the H-ECS 350 was unable to verify the credentials, the authentication verification response may indicate that the verification procedure performed by the H-ECS 350 failed.

In 560, the V-NEF 504 forwards the authentication verification response to the V-ECS 316. Thus, the authentication verification response may indicate that the verification procedure performed by the H-ECS 350 was a success. In 565, the V-ECS 316 transmits an application registration response to the UE 110. The V-ECS 316 may decide whether to accept or reject the authentication request from the UE 110. In thus example, it is assumed that the authentication was successful and thus, the application registration response may indicate a successful authentication. However, if for any of a variety of different reasons, the V-ECS 316 decides to reject the request, the application registration response may indicate a failed authentication and the failure reason.

In 570, the EEC 240 of the UE 110 and the V-ECS 316 establish a transport layer security (TLS) security tunnel. Thus, the VE 110 and the V-ECS 316 may establish the TLS security tunnel based on the pre-shared key (K_{edge}). Here, it is assumed that the UE 110 and the V-ECS 316 support TLS-PSK (pre-shared key). However, the exemplary embodiments are not limited to TLS-PSK protocol and may be applied to any appropriate type of protocol configured to provide secure communications based on a pre-shared key.

FIG. 6 shows a signaling diagram 600 for authentication based on primary authentication in an LBO roaming deployment scenario according to various exemplary embodiments. The signaling diagram 600 includes the same components at the signaling diagram 500 of FIG. 5.

In addition, 510-570 of the signaling diagram 500 aligns with 610-670 of the signaling of the signaling diagram 600. However, operation 542 is replaced in the signaling diagram 600 by operation 647. As described above, in 542, the H-AUSE 506 and the H-ECS 350 perform a credential update triggered in response to the generation of (K_{edge}, K_{edgeID}) by the H-AUSF 506. In contrast, in 647, the H-ECS 350 initiates a credential update procedure by sending a request for credentials to the H-AUSF 506. The H-AUSF 506 then provides the latest credentials (K_{edge}, K_{edgeID}) associated with the UE 110 and/or EEC 240 to the H-ECS 350.

FIG. 7 shows a signaling diagram 700 for authentication based on primary authentication in a HR roaming deployment scenario according to various exemplary embodiments. The signaling diagram 700 is described with regard to the network arrangement 100 of FIG. 1, the VE 110 of FIG. 2 and the architecture 400 of FIG. 4.

The signaling diagram 700 includes the UE 110, an AMF 702 of the VPLMN 402 (e.g., V-AMF 702), an NEF 704 of the VPLMN 402 (e.g., V-NEF 704), an AUSF 706 of the HPLMN 404 (e.g., H-AUSF 706), the H-ECS 450 and the V-ECS 416.

In 710, the UE 110 performs primary authentication with the network. Those skilled in the art will understand that the primary authentication procedure (e.g., 5G AKA, EAP-AKA, etc.) generally refers to an authentication procedure between the UE 110 and the core network 130. During the procedure, the H-AUSF 706 may generate a credential K_{AUSF} via authentication vector generation. The K_{AUSF} may be shared between the UE 110 and AUSF of the HPLMN (e.g., H-AUSF 706) and the K_{AUSF} may provide the basis of the subsequent 5G key hierarchy.

In 715, the UE 110 generates and stores one or more credentials. In this example, the credentials are referred to as “K_{edge}” and “K_{edgeID}.” However, reference “K_{edge}” and “K_{edgeID}” is merely for illustrative purposes, any appropriate credential or parameter may be utilized.

As described above, the credential K_{edge} may be derived from credential K_{AUSF}. For example, the input key for a key derivation function (KDF) may be the K_{AUSF}. When deriving K_{edge}, the following parameters may also be used for the KDF: FC, P0, L0. Here, FC may represent a parameter used to distinguish between different instances of the KDF. The value for FC may be any appropriate value allocated by a 3GPP based entity. The SUPI or any other identifier associated with the UE 110 (e.g., GPSI, etc.) may be used for P0. The length of the P0 parameter (e.g., SUPI, GPSI, etc.) may be used for L0. However, the above example is merely provided for illustrative purposes, the K_{edge} parameter may be derived in any other appropriate manner. The K_{edgeID} parameter may be used to uniquely identify a K_{edge} parameter. The K_{edgeID} parameter may be generated in any appropriate manner.

In 720, the H-AUSF 706 generates and stores one or more credentials. Here, the H-AUSF 706 generates the same credentials generated by the UE 110 in 715. Thus, in this example, the H-AUSF 706 may also generate the credentials K_{edge} and K_{edgeID}. Since the credential K_{AUSF} is shared between the UE 110 and the H-AUSF 706, the UE 110 and the H-AUSF 706 may independently generate the same credentials. However, reference to K_{AUSF} is merely provided for illustrative purposes, any appropriate type of information may be used to provide the basis for the one or more credentials generated in 715 and 720.

In 725, the EBC 240 of the UE 110 retrieves the one or more credentials from local database. For example, the EEC 240 may retrieve K_{edge} and K_{edgeID} from the memory arrangement 210 of the UE 110 or these credentials may be provided to the EEC 240 by another process executed by the processor 205.

In 730, the EEC 240 of the UE 110 may generate a MEC message authentication code (e.g., MAC_{EEC}). The authorization parameter may be generated using K_{edge} and the EEC ID associated with the EEC 240. For example, the MAC_{EEC} parameter may be generated using the SHA-256 hashing function. When deriving the MAC_{EEC} parameter, P0 and P1 may be used to form the input parameter S. Here, P0 represents K_{edge} and P1 represents the EEC ID. The input S shall be equal to the concatenation P0∥P1. The MAC_{EEC} parameter is identified with the N least significant bits of the output of the SHA-246 function, e.g., 32 bits, 64 bits, etc. However, the above example is merely provided for illustrative purposes, the MAC_{EEC} parameter may be derived in any other appropriate manner.

In 735, the UE 110 sends an application registration request to the V-ECS 416. The application registration request may include information such as, but not limited to, EEC ID, MAC_{EEC} and the K_{edgeID}. This message may be sent via non-access stratum (NAS), the user plane or in any other appropriate manner.

In 740, the V-ECS 416 sends the application registration request to the V-NEF 704. The application registration request may include information such as, but not limited to, EEC ID, MAC_{EEC} and the K_{edgeID}. In 745, the V-NEF 704 sends an authentication verification message to the H-AUSF 706. The authentication verification message may include contents similar to the application registration request in 735 (e.g., EEC ID, MAC_{EEC} and the K_{edgeID}).

In 750, the H-AUSF 706 sends the authentication verification message to the H-ECS 450. Prior to receiving the authentication verification message is received in 750, in 752, the H-AUSF 706 and the H-ECS 450 perform a credential update. Here, the H-AUSF 706 and the H-ECS 450 synchronize with regard to the credentials to be used for MEC authentication (e.g., EEC ID of the EEC 240, K_{edge}, K_{edgeID}, etc.). In this example, the credential update may be triggered in response to the generation of K_{edge}; K_{edgeID} by the H-AUSF 706. In other embodiments, the credential update may be triggered by the H-ECS 750 in response to the authentication verification message. For example, the H-ECS 450 may initiate a credential update procedure by sending a request for credentials to the H-AUSF 706 in response to the authentication verification message. The H-AUSF 706 may then provide the latest credentials (K_{edge}, K_{edgeID}) associated with the UE 110 and/or EEC 240 to the H-ECS 450. In another example, the updated credentials may be included in the authentication verification message received in 750.

In 755, the H-ECS 450 verifies the credentials provided in the authentication verification message. For example, the H-ECS 450 may retrieve K_{edge} from a local or remote database using the credential K_{edgeID}. The H-ECS 450 may then verify the MAC_{EEC} using K_{edge} and the EEC ID for the EEC 240.

In 760, the H-ECS 450 sends an authentication verification response to the H-AUSF 706. In this example, it is assumed that the verification was a success. Thus, the authentication verification response may indicate that the verification procedure performed by the H-ECS 450 was a success, However, if for any of a variety of different reasons, the H-ECS 450 was unable to verify the credentials, the authentication verification response may indicate that the verification procedure performed by the H-ECS 450 failed.

In the examples described above, the H-AUSF 706 operates as the authentication verifier with the ECS 450. However, the exemplary embodiments do not require the use of an AUSF and any appropriate type of one or more network functions may perform the operations described above with regard to the AUSF.

In 765, the H-AUSF 706 forwards the authentication verification response to the V-NEF 704. The authentication verification response may indicate that the verification procedure performed by the H-ECS 450 was a success. In 770, the V-NEF 704 forwards the authentication verification response to the V-ECS 416. The authentication verification response may indicate that the verification procedure performed by the H-ECS 450 was a success. In 775, the V-ECS 416 transmits an application registration response to the UE 110. The V-ECS 416 may decide whether to accept or reject the authentication request from the UE 110. In thus example, it is assumed that the authentication was successful and thus, the application registration response may indicate a successful authentication. However, if for any of a variety of different reasons, the V-ECS 416 decides to reject the request, the application registration response may indicate a failed authentication and the failure reason.

In 780, the EEC 240 of the UE 110 and the V-ECS 416 establish a TLS security tunnel. Thus, the UE 110 and the V-ECS 416 may establish the TLS security tunnel based on the pre-shared key (K_{edge}). Here, it is assumed that the UE 110 and the V-ECS 416 support TLS-PSK. However, the exemplary embodiments are not limited to TLS-PSK protocol and may be applied to any appropriate type of protocol configured to provide secure communications based on a pre-shared key.

FIG. 8 shows a signaling diagram 800 for authentication based on primary authentication in a HR roaming deployment scenario according to various exemplary embodiments. The signaling diagram 800 is described with regard to the network arrangement 100 of FIG. 1, the UE 110 of FIG. 2 and the architecture 400 of FIG. 4.

The signaling diagram 800 includes the same components as the signaling diagram 700 of FIG. 7, e.g., V-AMF 702, V-NEF 704, H-AUSF 706, H-ECS 450 and the V-ECS 416.

In addition, 810-845 of the signaling diagram 800 aligns with 710-745 of the signaling of the signaling diagram 700. In contrast to the signaling diagram 700, in 850, the H-AUSF 706 verifies the credentials provided in the authentication verification message in 745. For example, the H-AUSF 706 may retrieve K_{edge} from a local or remote database using the credential K_{edgeID}, The H-AUSF 706 may then verify the MAC_{EEC} using K_{edge} and the EEC ID for the EEC 240.

In 855, the H-AUSF 706 sends the authentication result to the H-ECS 450 to update the status of the EEC 240. In 860, the H-AUSF 706 sends an authentication verification response to the V-NEF 704. In this example, it is assumed that the verification was a success. Thus, the authentication verification response may indicate that the verification procedure performed by the H-AUSF 706 was a success. However, if for any of a variety of different reasons, the H-AUSF 706 was unable to verify the credentials, the authentication verification response may indicate that the verification procedure performed by the H-AUSF 706 failed.

In 865, the V-NEF 704 forwards the authentication verification response to the V-ECS 416. In 870, the V-ECS 416 transmits an application registration response to the VE 110. The V-ECS 416 may decide whether to accept or reject the authentication request from the UE 110. In this example, it is assumed that the authentication was successful and thus, the application registration response may indicate a successful authentication. However, if for any of a variety of different reasons, the V-ECS 416 decides to reject the request, the application registration response may indicate a failed authentication and the failure reason.

In 875, the EEC 240 of the UE 110 and the V-ECS 416 establish a TLS security tunnel. Thus, the UE 110 and the V-ECS 416 may establish the TLS security tunnel based on the pre-shared key (K_{edge}). Here, it is assumed that the UE 110 and the V-ECS 416 support TLS-PSK. However, the exemplary embodiments are not limited to TLS-PSK protocol and may be applied to any appropriate type of protocol configured to provide secure communications based on a pre-shared key.

### EXAMPLES

In a first example, one or more processors of an edge configuration server (ECS) deployed in a home public land mobile network (HPLMN) of a user equipment (UE) configured to perform operations, the operations comprising receiving an authentication verification message comprising at least an authorization parameter from a first network function, an identifier of a client running on the UE and an identifier corresponding to a first credential, retrieving the first credential using the identifier corresponding to the first credential, verifying the authorization parameter using the first credential and the identifier of the client running on the UE and transmitting a response to the authentication verification message to the first network function.

In a second example, the one or more processors of the first example, the operations further comprising receiving, prior to receiving the authentication verification message, a credential update message from a second network function of the HPLMN, the credential update message comprising at least the identifier of the client running on the UE, the first credential and the identifier corresponding to the first credential.

In a third example, the one or more processors of the second example, wherein the second network function is an authentication server function (AUSF) that generates the first credential and the identifier corresponding to the first credential based on a second credential generated for a primary authentication procedure.

In a fourth example, the one or more processors of the third example, wherein the second credential is K_{AUSF}.

In a fifth example, the one or more processors of the first example, wherein the first network function is a network exposure function (NEF) deployed in a visited public land mobile network (VPLMN).

### In a Sixth Example, the One or More Processors of the

first example, the operations further comprising transmitting, in response to receiving the authentication verification message, a credential update request to the first network function, the credential update message comprising at least the identifier of the client running on the UE, the first credential and the identifier corresponding to the first credential.

In a seventh example, the one or more processors of the sixth example, wherein the first network function is an authentication server function (AUSF) deployed in the HPLMN of the VE that generates the first credential and the identifier corresponding to the first credential based on a second credential generated for a primary authentication procedure.

In an eighth example, the one or more processors of the seventh example, wherein the second credential is K_{AUSF}.

In a ninth example, the one or more processors of the first example, the operations further comprising receiving, prior to receiving the authentication verification message, a credential update message from the first network function of the HPLMN, the credential update message comprising at least the identifier of the client running on the UE, the first credential and the identifier corresponding to the first credential.

In a tenth example, the one or more processors of the ninth example, wherein the first network function is an authentication server function (AUSF) that generates the first credential and the identifier corresponding to the first credential based on a second credential generated for a primary authentication procedure.

In an eleventh second example, the one or more processors of the tenth example, wherein the second credential is K_{AUSF}.

In a twelfth example, the one or more processors of the first example, wherein the UE configured to use a local breakout (LBO) roaming architecture to access the ECS.

In a thirteenth example, the one or more processors of the first example, wherein the UE configured to use a home routed roaming architecture to access the ECS.

In a fourteenth example, the one or more processors of the first example, wherein the response to the authentication verification message comprises at least the first credential and the identifier corresponding to the first credential.

In a fifteenth example, an edge configuration server (ECS) comprising the one or more processors of any of the first through fourteenth examples.

In a sixteenth example, a method to perform any of the operations of any of the first through fourteenth examples.

In a seventeenth example, computer readable storage medium comprising a set of instructions that when executed perform any of the operations of any of the first through fourteenth examples.

In an eighteenth example, one or more processors of a first network function deployed in a home public deployed in a home public land mobile network (HPLMN) of a user equipment (UE) configured to perform operations, the operations comprising receiving an authentication verification message comprising at least an authorization parameter from a second network function, an identifier of a client running on the UE and an identifier corresponding to a first credential, retrieving the first credential using the identifier corresponding to the first credential, verifying the authorization parameter using the first credential and the identifier of the client running on the UE and transmitting a response to the authentication verification message to the second network function.

In a nineteenth example, the one or more processors of the eighteenth example, wherein the second network function is a network exposure function (NEF) deployed in a visited public land mobile network (VPLMN) of the UE.

In a twentieth example, the one or more processors of the eighteenth example, the operations further comprising transmitting an authentication update comprising at least an authentication result derived based on verifying the authorization parameter to an edge configuration server (ECS) deployed in the HPLMN of the UE.

In a twenty first example, the one or more processors of the twentieth example, wherein the authentication update further comprises an identifier of a client running on the VE and the first credential.

In a twenty second example, the one or more processors of the twentieth example, wherein the VE configured to use a home routed roaming architecture to access the ECS.

In a twenty third example, the one or more processors of the eighteenth example, wherein the response to the authentication verification message comprises at least the first credential and the identifier corresponding to the first credential.

In a twenty fourth example, a method to perform any of the operations of any of the eighteenth through twenty third examples.

In a twenty fifth example, computer readable storage medium comprising a set of instructions that when executed perform any of the operations of any of the eighteenth through twenty third examples.

In a twenty sixth example, a method performed by a user equipment (UE), the method comprising transmitting an application registration request to an edge configuration server (ECS) of a visited public land mobile network (VPLMN) comprising at least an edge enabler client ID, an authorization parameter and an identifier for a first credential and establishing a transport layer security (TLS) security tunnel based on the first credential.

In a twenty seventh example, the method of the twenty sixth example, wherein the first credential is based on a second credential generated for a primary authentication procedure.

In a twenty eighth example, the method of the twenty sixth example, wherein the second credential is K_{AUSF}.

In a twenty ninth example, the method of the twenty sixth example, wherein the UE is configured to use a local breakout (LBO) roaming architecture to access an ECS deployed in a home public land mobile network (HPLMN) of the UE.

In a thirtieth example, the method of the twenty ninth example, wherein the ECS deployed in the HPLMN performs authentication of the authorization parameter.

In a thirty first example, the method of the twenty sixth example, wherein the UE is configured to use a home routed (HR) roaming architecture to access an ECS deployed in a home public land mobile network (HPLMN) of the UE.

In a thirty second example, the method of the thirty first example, wherein a network function deployed in the HPLMN performs authentication of the authorization parameter.

In a thirty third example, a processor configured to perform the methods of any of the twenty sixth through thirty second examples.

In a thirty fourth example, a user equipment comprising a transceiver configured to communicate with a network and a processor configured to perform the methods of any of the twenty sixth through thirty second examples.

In a thirty fifth example, a computer readable storage medium comprising a set of instructions that when executed perform the methods of any of the twenty sixth through thirty second examples.

In a thirty sixth example, a method performed by an edge configuration server (ECS) deployed in a visited public land mobile network (VPLMN) of a user equipment (UE), the method comprising receiving an application registration request from the UE comprising at least an authorization parameter, an identifier of a client running on the UE and an identifier corresponding to a first credential, receiving an authentication verification response from a network function deployed in the VPLMN, the verification response comprising at least the first credential and establishing a transport layer security (TLS) security tunnel with the UE based on the first credential.

In a thirty seventh example, the method of the thirty sixth example, the method further comprising transmitting, prior to receiving the authentication verification response, the application registration request to the network component, wherein a network component deployed in the HPLMN verifies the authorization parameter using the first credential and the identifier of the client running on the VE.

In a thirty eighth example, the method of the thirty seventh example, wherein the network component is an authentication server function (AUSF) deployed in the HPLMN.

In a thirty ninth example, the method of the thirty seventh example, wherein the network component is a second different ECS.

In a fortieth example, the method of the thirty sixth example, wherein the UE is configured to use a local breakout (LBO) roaming architecture to access an ECS deployed in the HPLMN.

In a forty first example, the method of the thirty sixth example, wherein the UE is configured to use a home routed (HR) roaming architecture to access an ECS deployed in the HPLMN.

In a forty second example, the method of the thirty sixth example, wherein a network function deployed in the HPLMN performs authentication of the authorization parameter.

In a forty third example, one or more processors configured to perform the methods of any of the thirty sixth through forty second examples.

In a forty fourth example, an edge configuration server (ECS) configured to perform the methods of any of the thirty sixth through forty second examples.

In a forty fifth example, a computer readable storage medium comprising a set of instructions that when executed perform the methods of any of the thirty sixth through forty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by an edge configuration server (ECS) deployed in a home public land mobile network (HPLMN) of a user equipment (UE), the method comprising:
receiving an authentication verification message comprising at least an authorization parameter from a first network function, an identifier of a client running on the UE and an identifier corresponding to a first credential;
retrieving the first credential using the identifier corresponding to the first credential;
verifying the authorization parameter using the first credential and the identifier of the client running on the UE; and
transmitting a response to the authentication verification message to the first network function.

2. The method of claim 1, further comprising:
receiving, prior to receiving the authentication verification message, a credential update message from a second network function of the HPLMN, the credential update message comprising at least the identifier of the client running on the UE, the first credential and the identifier corresponding to the first credential.

3. The method of claim 2, wherein the second network function is an authentication server function (AUSF) that generates the first credential and the identifier corresponding to the first credential based on a second credential generated for a primary authentication procedure.

4. The method of claim 3, wherein the second credential is K_{AUSF}.

5. The method of claim 1, wherein the first network function is a network exposure function (NEF) deployed in a visited public land mobile network (VPLMN).

6. The method of claim 1, further comprising:
transmitting, in response to receiving the authentication verification message, a credential update request to the first network function, the credential update request comprising at least the identifier of the client running on the UE, the first credential and the identifier corresponding to the first credential.

7. The method of claim 6, wherein the first network function is an authentication server function (AUSF) deployed in the HPLMN of the UE that generates the first credential and the identifier corresponding to the first credential based on a second credential generated for a primary authentication procedure, wherein the second credential is K_{AUSF}.

8. The method of claim 1, further comprising:
receiving, prior to receiving the authentication verification message, a credential update message from the first network function of the HPLMN, the credential update message comprising at least the identifier of the client running on the UE, the first credential and the identifier corresponding to the first credential.

9. The method of claim 8, wherein the first network function is an authentication server function (AUSF) that generates the first credential and the identifier corresponding to the first credential based on a second credential generated for a primary authentication procedure.

10. The method of claim 9, wherein the second credential is K_{AUSF}.

11. The method of claim 1, wherein the UE is configured to use a local breakout (LBO) roaming architecture to access the ECS.

12. The method of claim 1, wherein the UE is configured to use a home routed roaming architecture to access the ECS.

13. The method of claim 1, wherein the response to the authentication verification message comprises at least the first credential and the identifier corresponding to the first credential.

14. A method performed by a first network function deployed in a home public deployed in a home public land mobile network (HPLMN) of a user equipment (UE), the method comprising:
receiving an authentication verification message comprising at least an authorization parameter from a second network function, an identifier of a client running on the UE and an identifier corresponding to a first credential;
retrieving the first credential using the identifier corresponding to the first credential;
verifying the authorization parameter using the first credential and the identifier of the client running on the UE; and
transmitting a response to the authentication verification message to the second network function.

15. The method of claim 14, wherein the second network function is a network exposure function (NEF) deployed in a visited public land mobile network (VPLMN) of the UE.

16. The method of claim 14, further comprising:
transmitting an authentication update comprising at least an authentication result derived based on verifying the authorization parameter to an edge configuration server (ECS) deployed in the HPLMN of the UE.

17. The method of claim 16, wherein the authentication update further comprises an identifier of a client running on the UE and the first credential.

18. The method of claim 16, wherein the UE configured to use a home routed roaming architecture to access the ECS.

19. The method of claim 14, wherein the response to the authentication verification message comprises at least the first credential and the identifier corresponding to the first credential.

20. A method performed by a user equipment (UE), comprising:
transmitting an application registration request to an edge configuration server (ECS) of a visited public land mobile network (VPLMN) comprising at least an edge enabler client ID, an authorization parameter and an identifier for a first credential; and
establishing a transport layer security (TLS) security tunnel based on the first credential.
